(19) United States
(12) Patent Application Publication
(10) Pub. No.: US 2010/0077548 A1
(43) Pub. Date: Apr. 1, 2010

(54) VISUAL INDICATOR ASSEMBLY FOR BRAKE FOR BED

(75) Inventors: David Genske, Plover, WI (US); John R. Laverack, Southbury, CT (US); Kurt R. Weseman, South Meriden, CT (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: JOERNS HEALTHCARE, INC., Stevens Point, WI (US)

(21) Appl. No.: 12/563,823

(22) Filed: Sep. 21, 2009

Related U.S. Application Data
(60) Provisional application No. 61/098,243, filed on Sep. 19, 2008.

(51) Int. Cl. A61G 7/00; B60T 1/14; G09F 9/00

(52) U.S. Cl. 5/600; 188/5; 116/307

(57) ABSTRACT

A brake assembly includes a base member configured for attachment to the leg of a bed, a brake mounted to the base member, and a visual indicator assembly mounted in relation to the base member. The brake is operable to be selectively applied to prevent movement of the bed and the visual indicator assembly provides a visual indicia of when the brake is one of applied and released.

### CROSS-REFERENCE TO RELATED APPLICATIONS

This application claims the benefit of U.S. Provisional Application No. 61/098243, filed Sep. 19, 2008, the disclosure of which is incorporated herein by reference.

### BACKGROUND OF THE INVENTION

This invention relates in general to beds and more particularly to attachments or accessories for use with beds in the healthcare industry. Most particularly the present invention relates to a long term care bed including a caster assembly that permits movement of the bed and a brake that can be actuated to prevent movement of the bed when it is desirous to keep the bed in stationary position.

Beds used in the healthcare industry typically have a base frame that is raised and lowered in relation to a supporting surface and a patient support surface that has portions that tilt or move in relation to the base frame. Such beds are typically referred to as articulating beds. Caster assemblies for use with articulating beds are well known. They are generally attached to the legs of the bed to permit the bed to be moved. In some articulating beds, the legs move in relation to the supporting surface as the base frame is raised and lowered. Foot tubes of legs of existing articulating beds, when raising the base frame, move in a longitudinal direction. This movement sometimes translates to the base frame or patient support surface which, when in contact with a wall, can cause wall damage. A brake can be actuated to prevent movement of the bed when it is desirous to keep the bed in a stationary position.

### SUMMARY OF THE INVENTION

This invention relates to a brake assembly including a base member configured for attachment to the leg of a bed, a brake mounted to the base member, and a visual indicator assembly mounted in relation to the base member. The brake is operable to be selectively applied to prevent movement of the bed and the visual indicator assembly provides a visual indicia of when the brake is one of applied and released.

This invention also relates to a bed including a frame, an articulated patient support surface, at least one leg supporting the frame, and a caster assembly. The caster assembly includes a base member mounted to the leg, at least one caster mounted to the base member, a brake, and a visual indicator assembly. The brake is operable to be selectively applied to prevent movement of the bed. The visual indicator assembly provides a visual indicia indicative of a condition wherein the brake is applied and a second visual indicia indicative of a condition wherein the brake is released.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an exemplary bed for use in a healthcare industry.

FIG. 2 is an enlarged perspective view of a portion of the bed shown in FIG. 1 with a caster assembly.

FIG. 3 is an enlarged side elevational view of a portion of a caster assembly with casters engaging a supporting surface to permit movement of the bed.

FIG. 4 is an enlarged side elevational view of a portion of another caster assembly with casters engaging the supporting surface to permit movement of the bed.

FIG. 5 is a side elevational view of the caster assembly shown in FIG. 3, shown with a brake actuated to raise the casters out of engagement with the supporting surface to prevent movement of the bed.

FIG. 6 is a side elevational view of the caster assembly shown in FIG. 4, shown with a brake actuated to raise the casters out of engagement with the supporting surface to prevent movement of the bed.

FIG. 7 is a sectional view of the caster assembly shown in FIG. 4 with a side brake lever removed for clarity.

FIG. 8 is a sectional view of the caster assembly shown in FIG. 6 with a side brake lever removed for clarity.

FIG. 9 is a perspective view of a portion of a bed with a wall bumper.

FIG. 10 is a perspective view of a portion of the caster assembly and a visual indicator assembly with a side brake lever in a raised position.

FIG. 11 is a perspective view of a portion of the caster assembly visual indicator assembly with a side brake lever in a lowered position.

FIG. 12 is a perspective view of a visual indicator assembly with powered visual indicators.

FIG. 13 is an enlarged top plan view of the assembly shown in FIG. 12.

FIG. 14 is a front perspective view of the visual indicator assembly showing a housing thereof separated into first and second portions, which are arranged side by side.

FIG. 15 is a perspective view of the interior of a portion of the housing shown in FIG. 14.

FIG. 16 is a perspective view of a magnet of the visual indicator assembly and a mount for mounting the magnet to the caster assembly in relation to the housing.

FIG. 17 is an enlarged perspective view of a portion of the caster assembly and the visual indicator assembly, wherein mounting location of the magnet and mount are shown.

FIGS. 18 through 23 are top plan and side elevational views of caster assemblies with various visual indicator assemblies.

### DETAILED DESCRIPTION OF THE PREFERRED EMBODIMENT

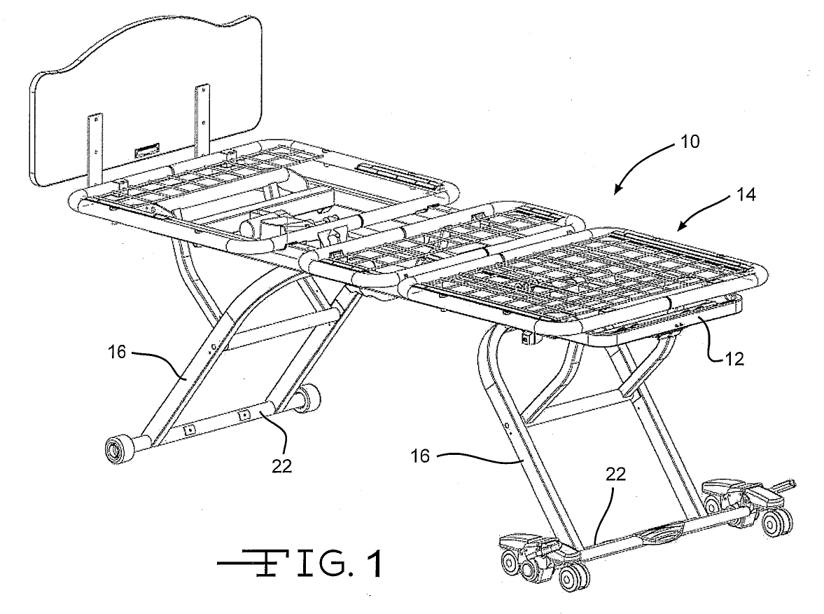

Referring now to the drawings, there is illustrated in FIG. 1 a perspective view of a portion of a bed, indicated generally at 10. The bed 10 is of the kind used in a healthcare industry. The bed 10 may be comprised of a base frame 12 and a patient support surface, indicated generally at 14, having one or more movable sections that may be supported in relation to the base frame 12. The movable sections may be comprised of tubular members, which may support a wire structure, which may in turn support a portion of a mattress (not shown). Although the illustrated bed 10 is an articulated bed, this is not required. The bed 10 may have a non-articulated patient support surface. The base frame 12 may be supported in relation to a supporting surface (e.g., the floor) by legs 16. The legs 16 may be driven by one or more actuators to raise and lower the base frame 12 with respect to the supporting surface.

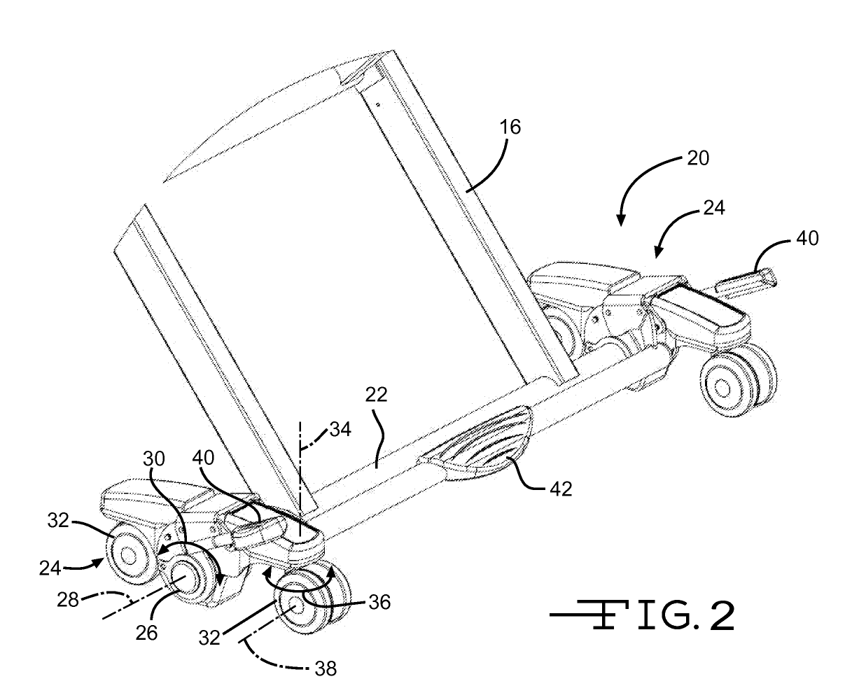

In FIG. 2 there is illustrated a perspective view of a portion of the bed 10 and the legs 16. The illustrated legs 16 are attached to a caster assembly 20 that may be mounted for pivotal movement in relation to the legs 16, or in relation to a foot tube 22 that extends laterally in relation to the legs 16. The caster assembly 20 may be comprised of one or more base members 24 that may be pivotally mounted in relation to the legs 16, or at opposing lateral ends of the foot tube 22. The base members 24 may be mounted in any desired manner. For example, the base members 24 may be mounted to opposing lateral ends of the foot tube 22 via radial bearings 26, such as shown in the drawings, so as to be pivotal about a pivot axis 28 in directions shown by line 30.

The base members 24 may have ends that may straddle the foot tube 22. The illustrated base members 24 include casters 32 located on each side (forward and rearward) of the foot tube 22. The casters 32 may be supported for pivotal movement about a pivot axis 34 in the direction of line 36 in relation to the ends of the base members 24. The casters 32 may rotate about an axis of rotation 38. It should be appreciated that while only one pivot axis 34 is shown, and only one axis of rotation 38 is shown, each of the casters 32 is configured to pivot and rotate.

The illustrated base members 24 are configured to allow the casters 32 to be raised and lowered relative to the support surface. This can be accomplished, for example, by the use of one or more brake levers, such as the opposing side brake levers 40 and the center brake lever 42 shown. When the casters 32 are raised relative to the support surface such that the casters 32 are no longer in contact with the support surface, the bed 10 is no longer able to roll relative to the support surface. Thus, raising the casters 32 helps to prevent movement of the bed 10.

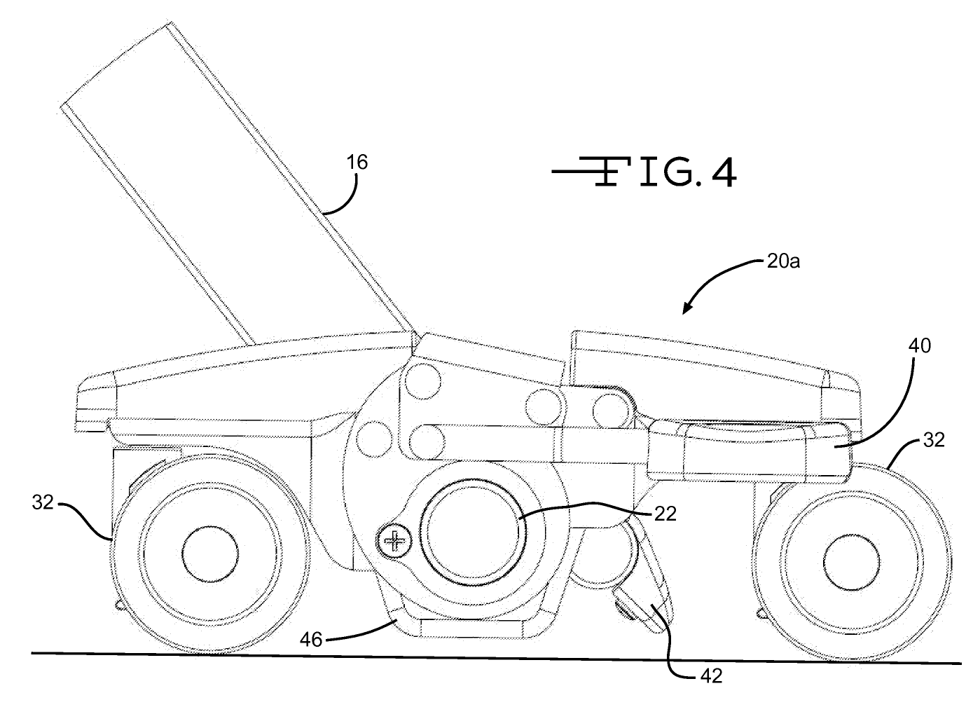

Referring to FIG. 3, a side view of one of the caster assemblies 20 is shown. As shown in FIG. 3, the casters 32 are engaging the support surface, and the bed 10 is capable of rolling on the casters 32. The caster assembly 20 is supported in relation to the foot tube 22 at the foot end of the bed 10. The illustrated foot tube 22 at the foot end of the bed 10 has cylindrical rollers 44 at its opposing lateral ends. When the casters 32 engage the supporting surface, the cylindrical rollers 44 and the foot tube 22 are raised out of engagement with the supporting surface, as shown in FIG. 3. Referring now to FIG. 5, the caster assembly 20 is shown with the brake lever 40 actuated to apply the brake. The casters 32 are raised out of engagement with the supporting surface, and the bed 10 is unable to roll on the casters 32. As the casters 32 rise out of engagement with the supporting surface, the cylindrical rollers 44 are lowered, together with the foot tube 22, to engage the supporting surface.

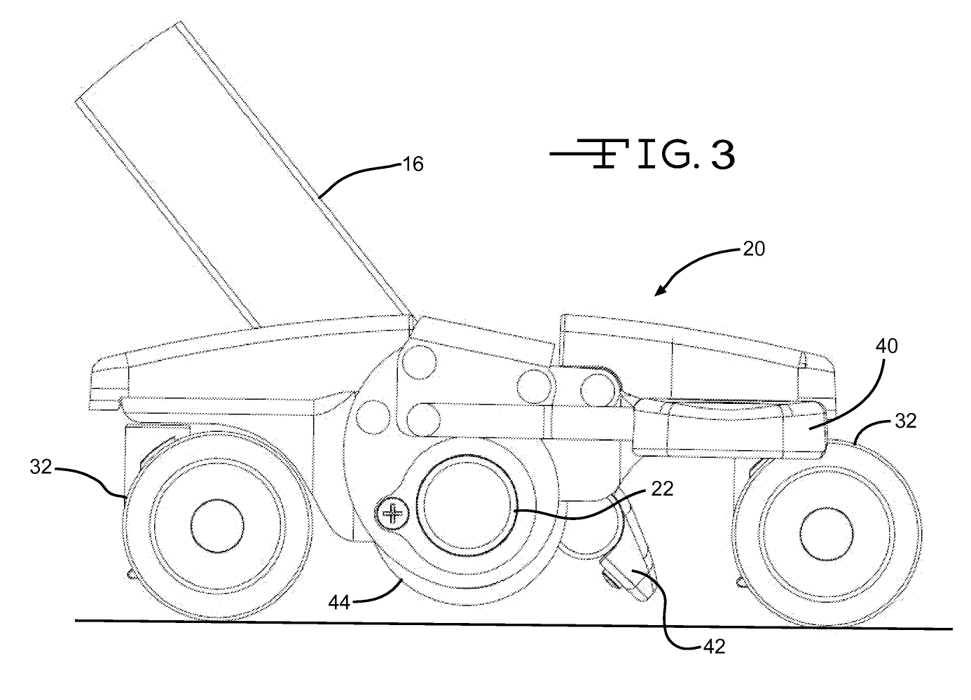

Referring to FIGS. 4 and 6, a similar caster assembly 20a is shown. The caster assembly 20a is supported in relation to the foot tube 22 at the head end of the bed 10. The illustrated foot tube 22 at the head end of the bed 10 has non-cylindrical rollers 46 at its opposing lateral ends. When the casters 32 engage the supporting surface, the non-cylindrical rollers 46 and the foot tube 22 are raised out of engagement with the supporting surface, as shown in FIG. 4. Referring to FIG. 6, the caster assembly 20a is shown with the brake lever 40 actuated to apply the brake. The casters 32 are raised out of engagement with the supporting surface, and the bed 10 is unable to roll on the casters 32. As the casters 32 rise out of engagement with the supporting surface, the non-cylindrical rollers 46 lower, together with the foot tube 22, to engage the supporting surface.

Although cylindrical rollers 44 are described as being at the foot end of the bed 10 and the non-cylindrical rollers 46 are described as being at the head end of the bed 10, it should be understood that any combination of cylindrical rollers and non-cylindrical rollers may be at either end of the bed 10. The cylindrical rollers 44 and the non-cylindrical rollers 46 may be formed from rubber or other desired material that may frictionally engage the supporting surface and thus help prevent movement of the bed 10. Further, it should be appreciated that the rollers may be replaced with non-rolling foot members.

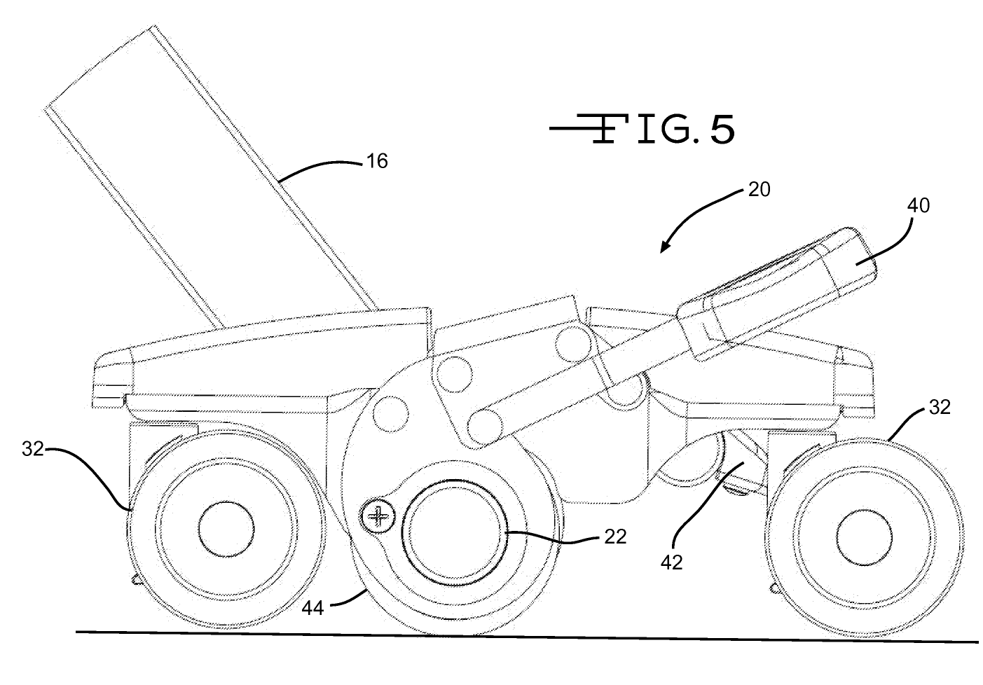

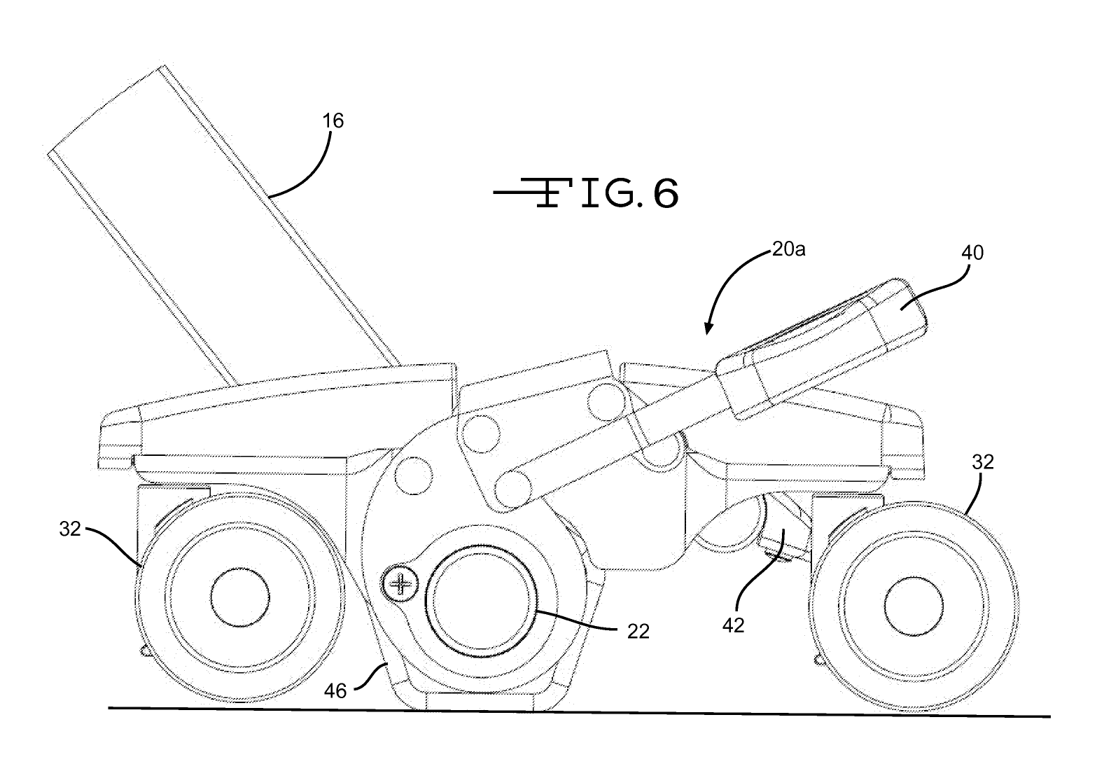

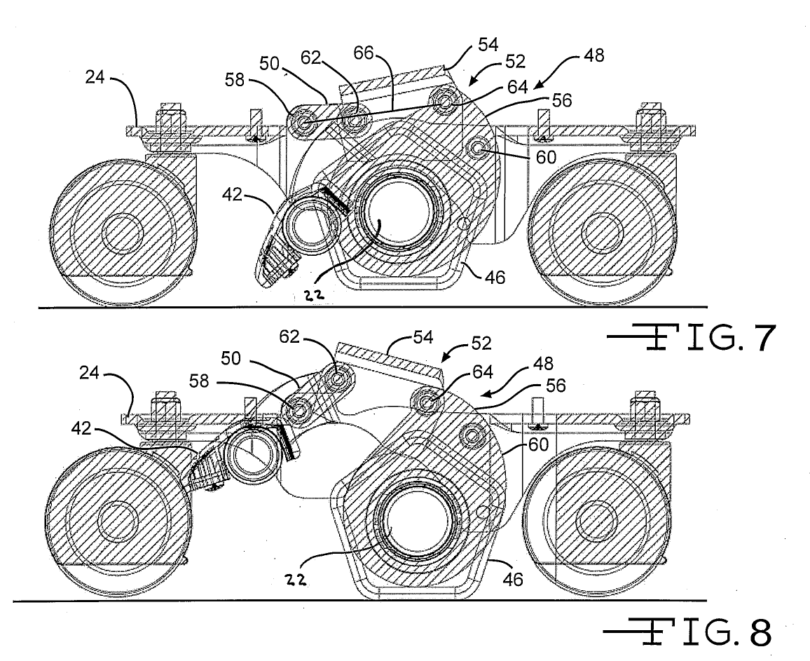

A linkage assembly 48 for applying the brake and thus raising and lowering the casters 32 is shown in FIGS. 7 and 8. Although the linkage assembly 48 is shown engaging and disengaging a non-cylindrical roller 46, the same linkage assembly 48 may engage and disengage the cylindrical roller 44. The linkage assembly 48 may be comprised of an over-center link 50, a coupler link 54, and an axle link 56. The coupler link 54 is part of a weldment 52 that includes the center brake lever 42. The over-center link 50 is supported for pivotal movement in relation to the base member 24 by the first fixed pivot 58. The axle link 56 is supported for pivotal movement in relation to the base member 24 by the second fixed pivot 60. The coupler link 54 is supported for pivotal movement in relation to the over-center link 50 by a first movable pivot 62. The coupler link 54 is supported for pivotal movement in relation to the axle link 56 by a second movable pivot 64.

Referring to FIG. 7, the side brake levers 40 and the center brake lever 42 are shown in their depressed positions. When the brakes are depressed, the over-center link 50 pivots clockwise (as viewed in FIGS. 7 and 8) about the first fixed pivot 58 and the axle link 56 pivots counter-clockwise about the second fixed pivot 60. As this occurs, the axle link 56 pivots in relation to the foot tube 22. Throughout this movement, the first moveable pivot 62 moves downward as the second movable pivot 64 moves upward. The first moveable pivot 62 moves to a bound position below an imaginary line 66 passing through the axial centers of the first fixed pivot 58 and the second movable pivot 64. When the first moveable pivot 62 is in the bound position, the casters 32 are held in engagement with the supporting surface and the non-cylindrical roller 46, the foot tube 22, the leg 16 are raised.

To raise the casters 32 and permit the bed 10, the leg 16, the foot tube 22, and the non-cylindrical roller 46 to be lowered, one of the side brake levers 40 and/or center brake lever 42 is raised to move the first moveable pivot 62 up and out of the bound position, as shown in FIG. 8.

It should be appreciated that the non-cylindrical roller 46 need not be a pentagon shaped roller, as shown but instead may be any suitable shape to resist rolling but permit limited rolling when sufficient force is applied. However, a non-cylindrical roller 46 in the form of a molded 70-80 Shore durometer rubber cored right regular pentagonal prism may be suitable for resisting movement of the leg 16 and thus preventing wall damage.

As shown in FIG. 9, a wall bumper 68 may be supported by the leg 16 or the foot tube 22 at the foot end of the bed 10. Although not shown, a caster assembly 20 may be supported in relation to the foot tube 22 at the foot end of the bed 10. In such case, the wall bumper 68 may be supported in relation to the caster assembly 20. In either event, as the base frame 12 is raised, the leg 16 at the head end of the bed 10 may move in the direction of a wall via the cylindrical rollers 44. Movement of the leg 16 is further prevented when the wall bumper 68 engages the wall. If the base frame 12 is not completely raised when the wall bumper 68 engages the wall, the base frame 12 continues to rise via movement of the leg 16 at the foot end of the bed 10. If the casters 32 are raised and the non-cylindrical rollers 46 are engaged with the supporting surface, the non-cylindrical rollers 46 rotate past an angled surface between adjacent flats. This may occur until the base frame 12 is completely raised, at which point the foot end of the bed 10 will rest on a flat, as shown in FIG. 8. Once at rest on this flat, the base frame 12 may be raised and lowered via movement of the leg 16 at the head end of the bed 10 via the cylindrical rollers 44, without the base frame 12 engaging the wall. This reduces the risk that the base frame 12 will damage a wall adjacent the head end of the bed 10.

It may be desirable for an attendant or other healthcare provider to readily know whether the brake is applied (i.e., whether the brake is actuated to prevent movement of the bed). To enable an attendant or other healthcare provider to readily determine whether the brake is applied, a visual indicator assembly may be provided.

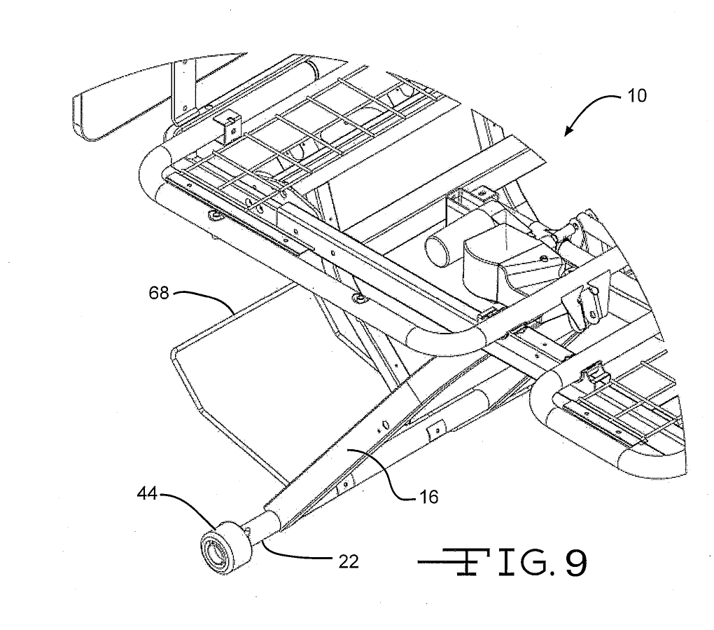

Referring to FIGS. 10 and 11, an example of a visual indicator assembly 70 is shown. The visual indicator assembly 70 is mounted in relation to one or more caster assembly 20. The visual indicator assembly 70 in this instance is the position of the brake levers 40, 42. The visual indicator assembly 70 informs the viewer whether the brake is applied by the position of the brake levers 40, 42.

The visual indicator assembly 70 may include instructional indicia representing instructions for operating the caster assemblies 20. For example, the visual indicator assembly 70 may include a graphic representation of a foot raising a lever, which informs a viewer that lifting either one of the side brake levers 40 or the center brake lever 42 locks the bed 10 in position (i.e., applies the brake). Additionally, the visual indicator assembly 70 may include a graphic representation of a foot lowering a lever, which informs the viewer that lowering either one of the side brake levers 40 or the center brake lever 42 unlocks the bed 10 (i.e., releases the brake).

The illustrated visual indicator assembly 70 includes graphic indicia that correspond to the condition of the brake. The graphic indicia may be placed on the visual indicator assembly 70 by printing, painting, applying as stickers, molding into the material of the visual indicator assembly 70, or by any other means desired. The visual indicator assembly 70 includes a first indicia for indicating when the brake is locked, and a second indicia for indicating when the brake is unlocked.

A lock indicia 70a includes graphic of a foot raising a lever along with a representation of a padlock in a locked condition. The lock indicia 70a indicates that the brake is applied and movement of the bed 10 is prevented when the brake levers 40, 42 are raised. An unlock indicia 70b includes a graphic of a foot lowering the lever along with a representation of a padlock in the unlocked condition. The unlock indicia 70b indicates that the brake is not applied and movement of the bed 10 is permitted when the brake levers 40, 42 are lowered. It should be appreciated that the lock indicia 70a may be a first color, and the unlock indicia 70b may be a second color, if desired. For instance, the lock indicia 70a may be red, and the unlock indicia 70b may be green.

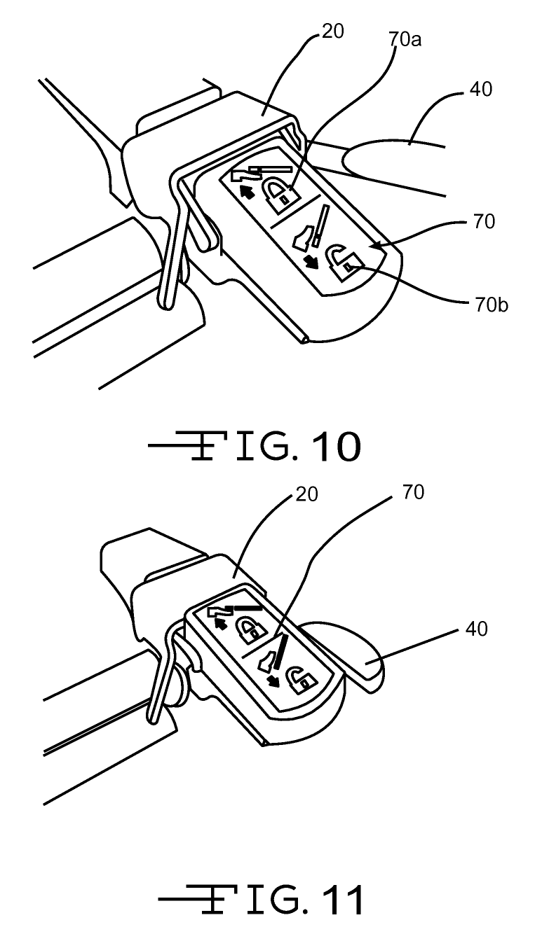

In FIG. 12, there is illustrated a powered visual indicator assembly 72. The powered visual indicator assembly 72 could be used as an optional retrofit assembly in the place of the visual indicator assembly 70 described above. The powered visual indicator assembly 72 could be provided with indicia representing instructions for operating the caster assemblies 20, like the visual indicator assembly 70 above. Additionally, the powered visual indicator assembly 72 could include features that illuminate or are illuminated depending on certain status condition, as also shown in FIG. 13. For example, the powered visual indicator assembly 72 may include a first feature 74 in the form of an area that illuminates to indicate that the brake is applied and a second feature 76 in the form of an area that illuminates to indicate that the brake is released. An optional third feature 78 may be in the form of an area that illuminates, for example, if a source of power, such as a battery, is near depletion.

In an exemplary embodiment, the first feature 74 may illuminate in a red color that could indicate that the brake is applied and the bed 10 is immobile. The second feature 76 may illuminate in a green color that could indicate that the brake is released and the bed 10 is mobile. The third feature 78 may illuminate in any color but is preferably a color that is easily distinguished from the illuminated colors of the first and second features 74, 76. In the exemplary embodiment, the third feature may illuminate in an amber color. The first feature 74, second feature 76, and third feature 78 may be any desired type of light, such as an incandescent light or a light emitting diode (LED). It should also be appreciated that the first feature 74, second feature 76, and third feature 78 may include a single light source that is selectively routed to the desired feature.

It should be appreciated that the first feature 74, second feature 76 and third feature 78 may be distinguished from each other by characteristics other than color or in addition to color. For instance, the first feature 74, second feature 76 and third feature 78 may have different shapes, they may have different orientations, they may have different brightness or different intensities, or they may flash or pulse with different frequencies.

To conserve energy consumption, the illuminated colors can be in the form of flashing lights, which may be in the form of blinking colored LEDs. A red LED may blink, for example, ten times for about five seconds when the brakes are applied. A green LED may blink, for example, two times per second when the brakes are released. An amber LED may blink, for example, when the battery is near depletion.

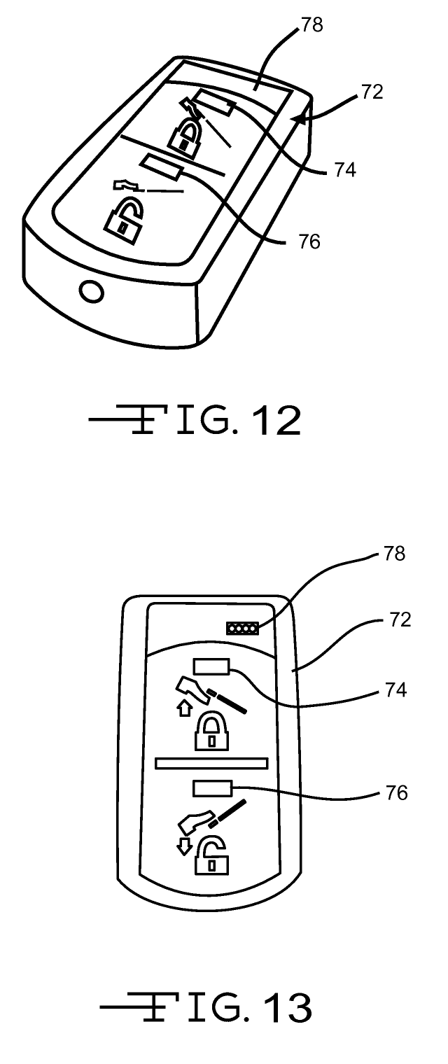

As shown in FIG. 14, the powered visual indicator assembly 72 may comprise a housing 80, which may be comprised of a first or lower portion 82, which may be supported in relation to the caster assembly 20, such as in relation to the base members 24, and a second or upper portion 84, which may be removably attached to the first portion 82, for example, for servicing (e.g., for battery replacement). The second portion 84 may be releasably attached to the first portion 82 in any suitable manner, such as with the aid of a threaded fastener, such as the screw 86 shown (see also FIG. 15).

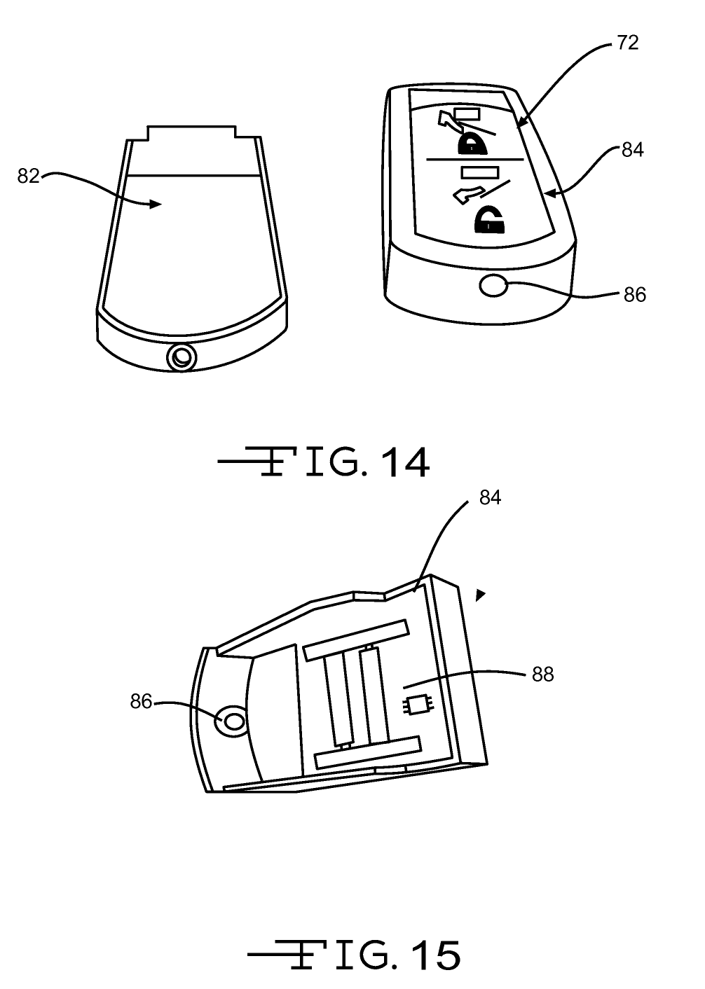

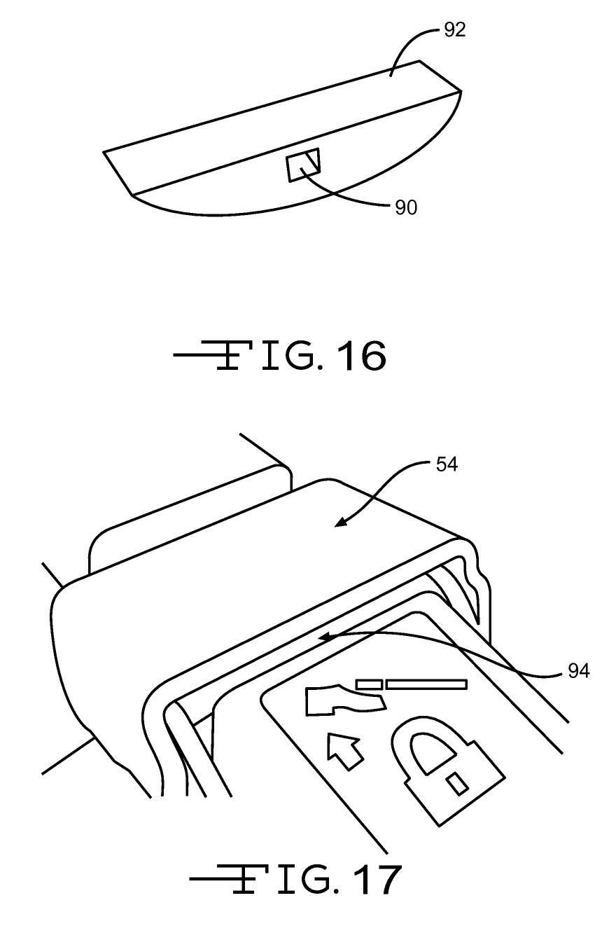

The powered visual indicator assembly 72 may be controlled by electronics and circuitry supported within the housing 80. The electronics and circuitry can be supported, together with a local power source (e.g., batteries), on a circuit board 88. A sensor, such as a Hall effect sensor, may be located on the circuit board 88. As shown in FIG. 16, a target, such as a magnet 90 may be supported in relation to a mount 92. The magnet 90 may be used to trigger or activate the sensor. The magnet 90 and mount 92 may be mounted, such as by adhesion or other suitable mounting technique, beneath the coupler link 54 (e.g., in the area generally indicated by arrow 94 in FIG. 17), or in another desired location. Upon depressing either one of the side brake levers 40 or the center brake lever 42 to apply the brake, the coupler link 54 pivots and the sensor senses the proximity of the magnet 90. This causes the illumination of the first feature 74. Upon raising either one of the side brake levers 40 or the center brake lever 42 to release the brake, the coupler link 54 pivots and the sensor, due to the change in proximity of the magnet 90, causes the illumination of the second feature 76. It should be appreciated that a sensor other than a Hall effect sensor may be used with the powered visual indicator assembly 72. Alternatively, the powered visual indicator assembly 72 may use a mechanical switch, or applying or releasing the brake may close or open a circuit that activates one of the first feature 74 and second feature 76.

The powered visual indicator assembly 72 may be self-contained, and configured to be resistant to water penetration. The powered visual indicator assembly 72 may be adapted to have an appearance and labeling scheme similar to other products. It should be appreciated that the powered visual indicator assembly 72 need not operate on batteries but instead may operate on a power source other than batteries, or in conjunction with batteries (e.g., a power source with battery back-up). In an exemplary embodiment, an AC power source can be converted to DC, which can power the powered visual indicator assembly 72. It should further appreciated that the powered visual indicator assembly 72 may be configured for other functionality, and/or integrated with a nurse call or other monitoring system.

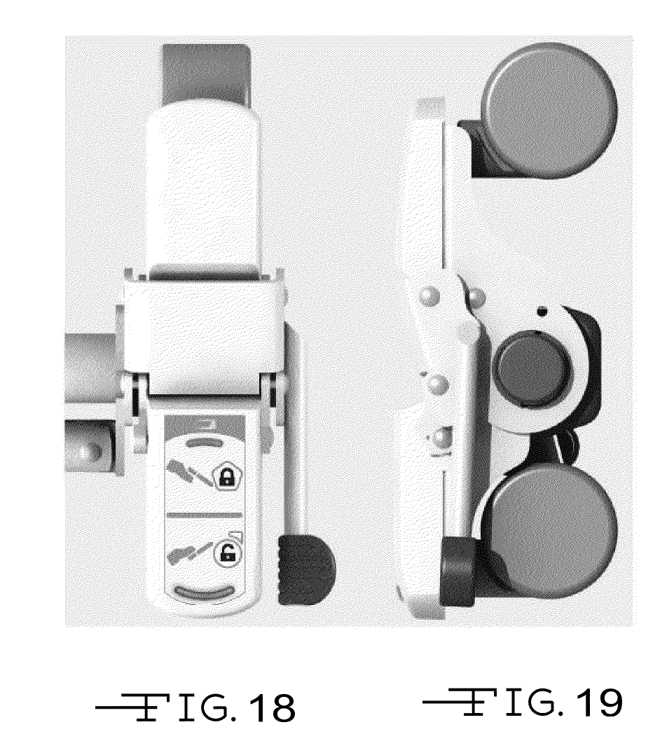

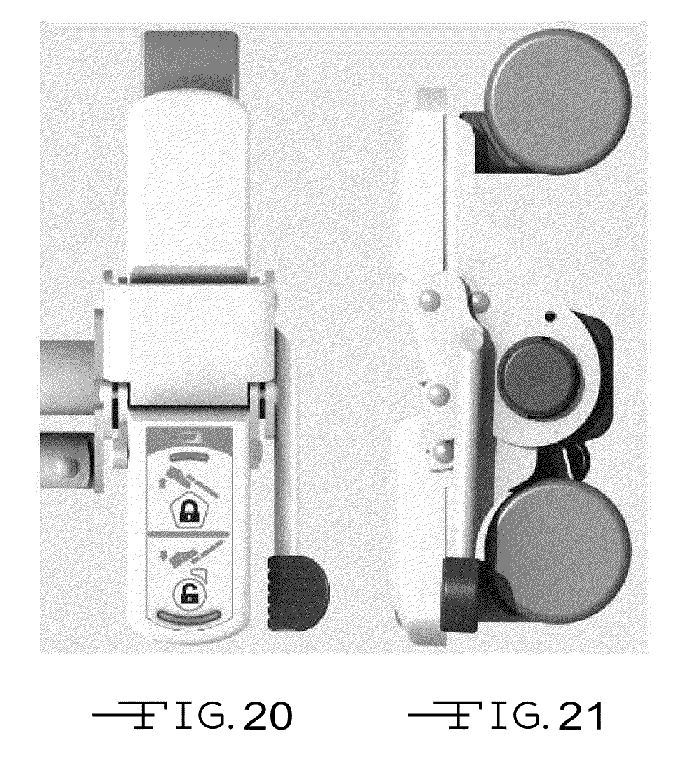

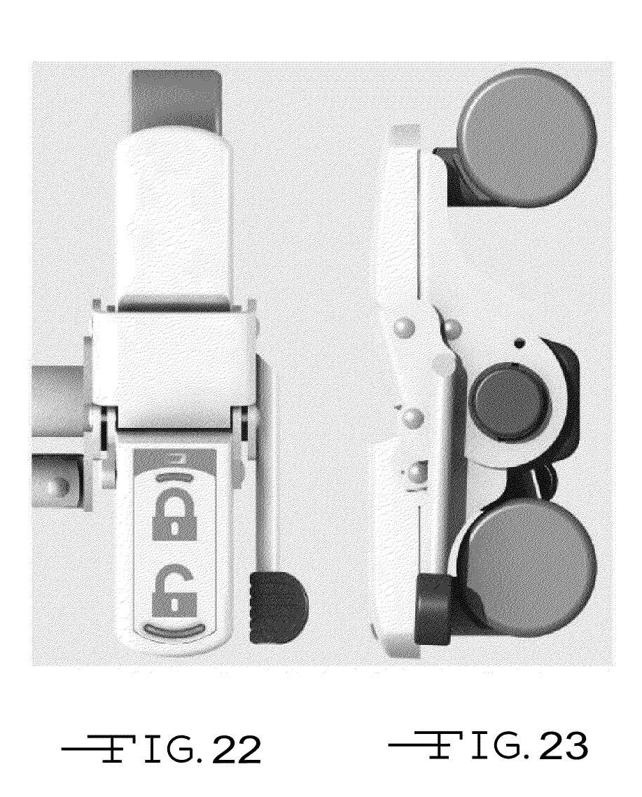

It should be appreciated that various other visual indicators are contemplated, as shown, for example, in FIGS. 18 through 23. The assemblies include various forms of indicia representing instructions for operating the brake. The indicia illustrated in FIGS. 18 and 19 include graphical representations of a lock in its locked or unlocked state, instructional indicia of a foot raising an lowering a lever, and graphical representations of a non-cylindrical roller or a caster. The indicia illustrated in FIGS. 20 and 21 include similar elements, but are arranged differently. The indicia illustrated in FIGS. 22 and 23 include graphical representations of a lock in its locked or unlocked state. The indicia may use different colors, as well as illuminated indicia.

It should be appreciated that while the visual indicator assembly 70 is shown in connection with a particular caster assembly 20, the visual indicator assembly 70 or the powered visual indicator assembly 72 may be used with other caster assemblies or with other brake mechanisms. In generally, the visual indicator assembly is suitable for use with a brake mechanism that may be applied to prevent movement of the bed and released to permit movement of the bed.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A brake assembly comprising:
a base member configured for attachment to the leg of a bed;
a brake mounted in relation to the base member and operable to be selectively applied to prevent movement of the bed and released to permit movement of the bed, and
a visual indicator assembly mounted in relation to the base member, the visual indicator assembly providing a visual indicia of when the brake is one of applied and released.

2. The brake assembly of claim 1, further comprising a caster supported in relation to the base member.

3. The brake assembly of claim 2, wherein the brake comprises a member that selectively engages a supporting surface to cause the caster to rise out of engagement with the supporting surface.

4. The brake assembly of claim 3, wherein the visual indicia is a graphic indicia.

5. The brake assembly of claim 4, wherein the visual indicia includes instructions for operating the brake.

6. The brake assembly of claim 5, wherein the visual indicator assembly further provides a second visual indicia of when the brake is the other of applied and released.

7. The brake assembly of claim 6, wherein the visual indicia is a first color, and the second visual indicia is a second color that is different from the first color.

8. The brake assembly of claim 7, wherein the visual indicia is illuminated and the second visual indicia is illuminated.

9. The brake assembly of claim 1, wherein the visual indicia is a graphic indicia.

10. The brake assembly of claim 10, wherein the visual indicia includes instructions for operating the brake.

11. The brake assembly of claim 10, wherein the visual indicator assembly further provides a second visual indicia indicative of a condition wherein the brake is the other of applied and released.

12. The brake assembly of claim 11, wherein the visual indicia is a first color, and the second visual indicia is a second color that is different from the first color.

13. The brake assembly of claim 12, wherein the visual indicia is illuminated and the second visual indicia is illuminated.

14. The brake assembly of claim 11, wherein the visual indicia is illuminated and the second visual indicia is illuminated.

15. The brake assembly of claim 1, wherein the visual indicia is illuminated.

16. The brake assembly of claim 1, further comprising:
a housing supported in relation to the base member;
a sensor mounted to one of the base member and the brake; and
a target mounted to the other of the base member and the brake;
wherein the visual indicator is illuminated when the sensor detects the target.

17. The apparatus of claim 16, wherein the visual indicator assembly comprises a housing having a first portion supported in relation to the base member and a second portion removably attached to the first portion, and a battery within the housing.

18. The brake assembly of claim 17, further comprising a caster supported in relation to the base member;
wherein the brake comprises a member that is configured to selectively engage a supporting surface to cause the caster to rise out of engagement with the supporting surface.

20. A bed comprising:
a base frame;
a patient support surface having one or more sections that are supported for movement in relation to the base frame;
at least one leg supporting the base frame in relation to a supporting surface;
a caster assembly comprising:
at least one base member mounted for pivotal movement in relation to the leg,
at least one caster supported for pivotal movement in relation to the base member,
at least one brake operable to be selectively applied to prevent movement of the bed and released to permit movement of the bed, and
a visual indicator assembly mounted in relation to the base member, the visual indicator assembly providing a visual indicia indicative of a condition wherein the brake is applied and providing a second visual indicia indicative of a condition wherein the brake is released.

20. The bed of claim 20, wherein the visual indicia is illuminated and the second visual indicia is illuminated.
